(19) United States
(12) Patent Application Publication
(10) Pub. No.: US 2004/0002623 A1
(43) Pub. Date: Jan. 1, 2004

(54) Encapsulation of spent ceramic nuclear fuel

(76) Inventor: Tihiro Ohkawa, La Jolla, CA (US)

Correspondence Address: NEIL K. NYDEGGER, NYDEGGER & ASSOCIATES, 348 Olive Street, San Diego, CA, 92103, US

(21) Appl. No.: 10/186,413

(22) Filed: Jun. 28, 2002

(51) Int. Cl. G21F 9/00

(52) U.S. Cl. 588/11

(57) ABSTRACT

A method for vitrifying a plurality of nuclear waste kernels includes coating the kernels with a glass layer, and mixing the glass-coated kernels in a glass melt. Subsequent cooling solidifies the glass melt and vitrifies the nuclear waste kernels in bulk vitrification glass. Importantly, the glass layer has a softening temperature that is higher than the softening temperature of the glass melt. The glass layer also has a variable thermal expansion coefficient across the layer. Additionally, the glass melt has substantially the same specific gravity as the glass-coated kernels in order to effect a uniform distribution of the glass-coated kernels throughout the bulk vitrification glass.

### FIELD OF THE INVENTION

The present invention pertains generally to devices and methods for depositing spent nuclear waste fuel from a once-through cycle of a nuclear reactor. More particularly, the present invention pertains to devices and methods for vitrifying spent nuclear fuel kernels that have a protective silicon carbide layer. The present invention is particularly, but not exclusively, useful as a method for vitrifying kernels in a way which controls heat dissipation through the glass that encapsulates the kernels.

### BACKGROUND OF THE INVENTION

In the operation of a high temperature gas-cooled reactor (HTGR), spent nuclear waste fuel is produced that typically includes a large number of small multi-layered kernels. Structurally, each kernel has a soft carbon layer that surrounds a radioactive core, and a pyrolytic carbon layer that surrounds the soft carbon layer. There is then a silicon carbide layer surrounding the pyrolytic carbon layer that acts as a diffusion barrier, and there is also an additional pyrolytic carbon layer that surrounds the silicon carbide layer. Further, these multi-layered kernels are embedded in a graphite matrix which substantially prevents the fuel and the fission products from escaping through the graphite matrix. Once the fuel has been spent, these kernels need to either be properly disposed of, or recycled.

When spent fuel can be recycled and reprocessed, the silicon layers of the spent fuel kernels are typically crushed to expose the radioactive uranium cores. The radioactive materials are then reused. In some countries, however, such as the United States, spent fuel from HTGR can not be reprocessed. Thus, HTGR spent fuel must be disposed of safely.

A well known and particularly effective method for disposing of various types of nuclear waste is a process known as vitrification or glassification. In such a process, the nuclear waste is mixed with a glass melt which is subsequently cooled until it solidifies. As a result, the nuclear waste becomes encapsulated in bulk vitrification glass (i.e. solidified glass melt). A concern with such a vitrification process, however, is that the heat which is dissipated from the radioactive material must somehow be controlled. Not surprisingly, if too much heat is dissipated by radioactive decay, the glass that encapsulates the nuclear waste may not solidify or, once solidified, may melt. For obvious reasons, this result can be extremely hazardous and must be avoided.

In order to determine the amount of heat that is dissipated by spent fuel from a HTGR and needs to be controlled after it is vitrified, each kernel can be considered as a heat source. The temperature rise caused by each of the kernels that is embedded in bulk vitrification glass can then be estimated and their collective effect evaluated. To begin, the fuel core of a kernel is typically a uranium oxide sphere having a diameter of approximately 250 microns. The specific gravity of uranium oxide is 11 and the number of uranium nuclei in a fuel core, N, is 1.3×10¹⁹. If the enrichment factor is ε and the burn up factor is b, the number of the fission events, N_{f}, can be expressed as

N_{f}=ε b N. [1]

Hence, for example, if ε=0.2 and b=0.2, the number of fission events, N_{f}, is 5.2×10¹⁷.

It is possible, however, that spent HTGR fuel will possibly have several different fission products. With this in mind, the radioactive fission products with short lives will most likely be decayed out by the time vitrification occurs. On the other hand, the fission products with very long lives will not contribute significantly to the heat generation. There are, however, two important fission products present in spent nuclear fuel that have intermediate decay times which are of concern. These two fission products are the main sources of heat and are: Strontium 90 (Sr 90) and Cesium 137 (Cs 137).

In radioactive disintegration, the average energy of electrons in β-decay is about ⅓ of the decay energy. For the materials Strontium 90 (Sr 90) and Cesium 137 (Cs 137), the heat output is respectively 0.69 microwatt, and 3.1 microwatt. Because the range of electrons in glass, as they are emitted from fission products, is 1 mm and the range of γ is of the order of 10 cm, if the heat source is a sphere having a radius “a,” the temperature distribution can be expressed as

T=[P/4 π K r]+T_{∝} [2]

In this operation, P is the heating power, K is the thermal conductivity and T_{∝}is the temperature far away from the source. The temperature rise at radius “a” is thus given by

Tₐ−T_{∝}=P/[4 π K a]. [3]

With P=3.8×10⁻⁶ w, K=1 w/m °K., and a=1 mm, the temperature rise at radius “a” is Tₐ−T_{∝}=3.0×10⁻⁴ °K. Thus, the local heating of each kernel is relatively small.

Next, using an estimation of the local heating of each kernel, the overall temperature rise of the glass can be calculated. To calculate global heating, the glass that encapsulates the kernels can be, for example, a spherical pebble having a radius R. The number of kernels dispersed in the glass of such a spherical pebble is v kernels per unit volume in glass. The temperature distribution is then given by

T=[ν P/6 K][R²−r²]+T_{R} [4]

where T_{R} is the surface temperature and the maximum temperature rise T₀−Tᵣ is given by

T₀−T_{R}=ν P R²/[6 K]. [5]

If the temperature rise is limited to 100° K and P=3.8×10⁻⁶ w, R=0.1 m and K=1 w/m ⁰K, the value of ν is 1.6×10¹⁰ m⁻³. The average distance between the kernels is given by ν^{-1/3}. For this example, the distance is 0.4 mm. Thus, the distance between two kernels is comparable to the radius of a kernel (250 μm). This then indicates that the kernels can be packed as close as practicable without undue temperature rise.

Another consideration when vitrifying kernels is the optimal size and shape (i.e. spherical pebble) of the bulk vitrification glass that encapsulates the kernels. In particular, the optimal size of the bulk vitrification glass is limited by the temperature rise and may be obtained by setting

ν[4 π r³/3]≈0.5 [6]

where “r” is the radius of the kernel. Tightly packed kernels occupy about 70% of the volume and the value of the number of kernels per volume of glass, ν, (determined above to be ν=1.6×10¹⁰ m⁻³) is close to the maximum number of kernels allowed in a volume of glass without the kernels touching each other. However, due to unavoidable inhomogeneous distribution of the kernels, a slightly smaller value for ν may be chosen. With this in mind, the combination of eq [5] and eq [6] yields

R²=[16 π][T₀−T_{R}]r³ K/P. [7]

With T₀−T_{R}=100° C., K=1 w/m²° C., P=3.6×10⁻⁶ w and r=3.5×10⁻⁴ m, the radius of the spherical glass pebble (i.e. bulk vitrification glass) is R=0.24 m and the total thermal power per sphere is 0.58 kw.

The size of the spherical glass pebble is determined by the amount of heat that must be removed from the surface of the glass pebble. If the surface heat removal rate is the design criterion, the size of the glass pebble is chosen by

R=3 Q/[ν P] [8]

where Q is the surface cooling rate. With R=0.24 m, the cooling rate is 0.8 kw/m². If a lower cooling rate is preferred, a smaller radius should be chosen.

Insofar as the glass pebble is concerned, another consideration when vitrifying spent fuel kernels is the thermal stress caused by thermal expansion of the bulk vitrification glass, as heat dissipates from the radioactive material of the kernels. As this heat dissipates through the glass pebble, and is removed from the surface of the glass pebble, it may cause the glass pebble to expand and soften. In particular, concentrations of heat can be generated if there are unwanted high density concentrations of kernels. Thus, a substantially uniform distribution of kernels throughout the glass pebble should be obtained to maintain the integrity of the glass pebble and, hopefully, avoid a potential meltdown of the glass pebble.

In light of the above, it is an object of the present invention to provide a method for vitrifying nuclear waste that allows heat to be removed from the glass at a predictable and reasonable rate without compromising the integrity of the glass. Another object of the present invention is to provide a method for vitrifying nuclear waste kernels in a glass that avoids excessive thermal stress on the kernels as they are being embedded in the glass. Still another object of the present invention is to provide a method for vitrifying nuclear waste with a uniform distribution of the kernels in the glass. Yet another object of the present invention is to provide a method for nuclear waste remediation which is relatively easy to implement, simple to use and comparatively cost effective.

### SUMMARY OF THE PREFERRED EMBODIMENTS

The present invention is directed to devices and methods for vitrifying a plurality of HTGR nuclear waste kernels for subsequent storage or disposal. With this purpose in mind, it is necessary to recognize that each kernel of HTGR nuclear waste essentially includes a core of radioactive nuclear material that is surrounded by a layer of silicon carbide. As a fuel for HTGR, a plurality of these kernels are embedded in a carbon/graphite matrix. For an overview of the present invention, the method includes first removing the carbon/graphite matrix. The exposed kernels are then coated with a glass layer. Finally, the glass-coated kernels are mixed into a glass melt which is then cooled to vitrify the kernels in bulk vitrification glass.

As indicated above, in order to prepare the kernels of HTGR waste for vitrification in accordance with the present invention, the carbon/graphite matrix surrounding each kernel is first removed by any means known in the pertinent art, such as by burning, to expose the silicon carbide layer. Next, the kernels are pre-coated with a glass layer that tightly bonds to the surface of the silicon carbide layer. Importantly, this pre-coated glass layer has a variable thermal expansion coefficient (TEC) across the glass layer. Specifically, the TEC of the portion of the glass layer nearest the silicon carbide layer needs to be substantially equal to the TEC of silicon carbide. On the other hand, the TEC of the portion of the glass layer that is near the outer surface of the glass layer needs to be substantially equal to the TEC of the glass melt in which the coated kernels are vitrified. Of equal importance, the glass layer that coats the kernel needs to have a higher softening temperature than that of the glass melt. This is important because, as heat dissipates from the kernel core, the glass layer will maintain its integrity even though the bulk vitrification glass may begin to soften.

In accordance with the present invention, the coating of the kernels with a glass layer having a variable TEC, is preferably accomplished by chemical vapor deposition (CVD). To do this, the kernels are first placed in the chamber of a fluidized bed processor. For its operation, the chamber will preferably contain nitrogen gas or argon gas, or any other suitable inert gas. The chamber will also contain a gas mixture for the glass that is to be coated onto the kernels by CVD. Specifically, this gas mixture preferably includes a silicon gas, oxygen and any other suitable gaseous element that is needed to make a particular kind of glass for the glass layer. For example, the gaseous element can be borane to make boro-silicate glass. Additionally, a mixing gas can be added to the gas mixture in the chamber in a predetermined manner to vary the TEC of the glass layer as it is being deposited on the kernels. As intended for the present invention, suitable mixing gases for this purpose include, for example, silane, borane, phosgen, triiosbutylaluminum and arsine.

After the kernels have been coated with the glass layer, the glass-coated kernels are then mixed with a glass melt to form a mixture. As intended for the present invention, the specific gravity of the glass melt is selected to be substantially the same as the specific gravity of the kernels. This matching of specific gravities is important in order to prevent the kernels from settling in the glass melt, and to thereby obtain a more uniform distribution of the kernels throughout the bulk vitrification glass when the glass melt is cooled and solidified. In order to alter the specific gravity of the glass melt to substantially match that of the glass-coated kernels, either light-weight elements or heavy-weight elements can be added to the glass melt as required.

After altering the specific gravity of the glass melt, the mixture is then cooled to solidify the glass melt and vitrify the glass-coated kernels in bulk vitrification glass. Preferably, the mixture is cooled to a substantially sphere-shaped configuration. Alternatively, however, the cooled mixture can be cylindrical-shaped.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a pebble used in a HTGR, with a portion of the pebble removed to show a plurality of spent nuclear fuel kernels therein;

FIG. 2 is a perspective view of a kernel of the present invention, with a portion removed for clarity;

FIG. 3 is an operational flow chart of the vitrification steps of the present invention;

FIG. 4 is a schematic of the processing components used in the vitrification method of the present invention; and

FIG. 5 is a cross-sectional view of a glass-coated kernel of the present invention as seen along the line 5-5 in FIG. 4.

### DESCRIPTION OF THE PREFERRED EMBODIMENT

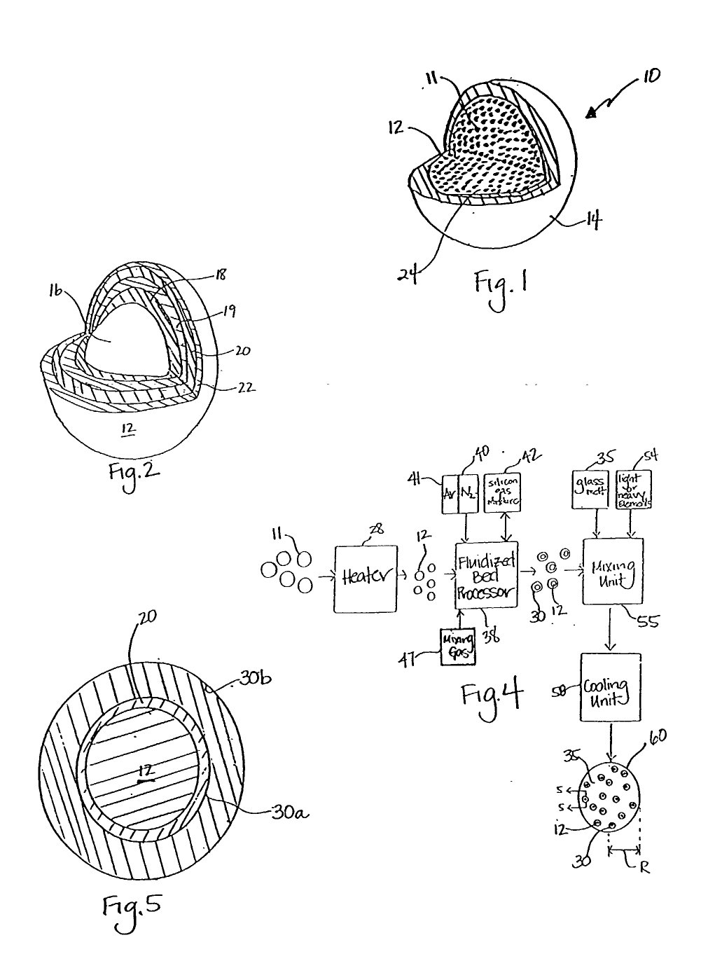

Referring initially to FIG. 1, a pebble used in a HTGR in accordance with the present invention is shown and is generally designated 10. As shown, the pebble 10 includes nuclear waste 11 in the form of a plurality of nuclear waste kernels 12. As also shown in FIG. 1, a graphite shell 14 encapsulates the nuclear waste 11.

The structural details of an exemplary kernel 12 that is to be vitrified in accordance with the present invention can perhaps be best seen in FIG. 2, wherein it is shown that the kernel 12 is multi-layered. Specifically, the kernel 12 has a core 16 of radioactive nuclear material, a soft carbon layer 18 that surrounds the core 16, and a pyrolytic carbon layer 19 that surrounds the soft carbon layer 18. As also shown in FIG. 2, there is a silicon carbide layer 20 that surrounds the pyrolytic carbon layer 19, and an outer pyrolytic carbon layer 22 that surrounds the silicon carbide layer 20. Lastly, the multi-layered kernel 12 is embedded in graphite 24, as shown in FIG. 1.

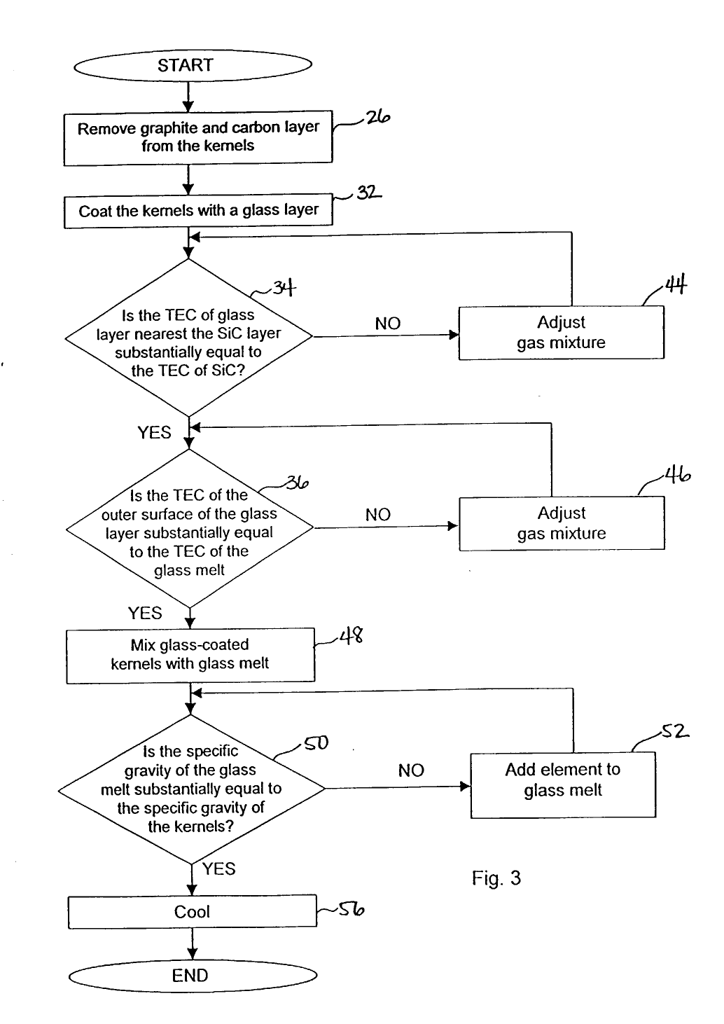

The operational details of the present invention will be best appreciated by cross-referencing FIGS. 3 and 4. To begin, the graphite 24 and the outer pyrolytic carbon layer 22 of each kernel 12 are first removed, as indicated by action block 26 in FIG. 3. This can be done by any means known in the pertinent art, such as by passing the nuclear waste 11 through a heater 28, as shown in FIG. 4, to burn off the graphite 24 and the carbon layer 22 from the kernels 12. Importantly, the silicon carbide layer 20 of each kernel 12 is exposed as a result of the removal of the graphite 24 and the pyrolytic carbon layer 22.

Next, the kernels 12 are coated with a glass layer 30, as indicated by action block 32 in FIG. 3. An important aspect of the present invention is that the glass layer 30 has a variable thermal expansion coefficient (TEC) across the glass layer 30. In FIG. 5, this variation is indicated by layers 30a and 30b. Specifically, as shown in FIG. 5, the TEC of the portion of the glass layer 30a nearest the silicon carbide layer 20 needs to be substantially equal to the TEC of silicon carbide, as indicated by decision block 34 in FIG. 3. On the other hand, the TEC of the outermost portion of the glass layer 30b (shown in FIG. 5) needs to be substantially equal to the TEC of the glass melt 35, as indicated by decision block 36 in FIG. 3. Of equal importance, the glass layer 30 that is coating the kernels 12 needs to have a higher softening temperature than that of the glass melt 35. This is important because the glass layer 30 must maintain its integrity, as heat dissipates from the kernel core 16, even though the bulk vitrification glass may begin to soften.

The coating of the kernels 12 with a glass layer 30 having a variable TEC, is preferably accomplished by chemical vapor deposition (CVD). To do this, the kernels 12 are first placed in the chamber of a fluidized bed processor 38, as shown in FIG. 4. The chamber will preferably contain nitrogen gas 40 or argon gas 41, or any other suitable inert gas for its operation. Still referring to FIG. 4, the chamber will also contain a gas mixture 42 for the glass that is to be coated onto the kernels 12 by CVD. Preferably, this gas mixture 42 includes a silicon gas, oxygen, and any other suitable gaseous element that is needed to make a particular kind of glass for the glass layer 30. By way of example, the gaseous element can be phosgen to make phosphosilicate glass. Importantly, as indicated by action blocks 44 and 46 in FIG. 3, a mixing gas 47 (shown in FIG. 4) can be added in a predetermined manner to the gas mixture 42 in the chamber, to vary the TEC of the glass layer 30, as it is being deposited on the kernels 12. Suitable mixing gases 47 for this purpose include, for example, silane, borane, phosgen, triiosbutylaluminum and arsine. Alternatively, to vary the TEC of the glass layer 30, a portion of the gas mixture 42 in the chamber can be removed. The end product of this coating step, a glass-coated kernel 12, is shown in FIG. 5.

After the kernels 12 have been coated with the glass layer 30, the glass-coated kernels 12 are then placed in a mixing unit 55 (shown in FIG. 4) to be mixed with a glass melt 35, as indicated by action block 48 in FIG. 3. In accordance with the present invention, the specific gravity of the glass melt 35 is selected to be substantially the same as the specific gravity of the kernels 12, as designated by decision block 50 in FIG. 3. This is an important aspect of the present invention because this matching of specific gravities prevents the kernels 12 from settling in the glass melt 35, and therefore, a more uniform distribution of the kernels 12 can be obtained throughout the bulk vitrification glass (i.e. solidified glass melt 35). In order to alter the specific gravity of the glass melt 35 to substantially match that of the glass-coated kernels 12, as indicated by action block 52 in FIG. 3, elements 54, as shown in FIG. 4, being either light-weight elements or heavy-weight elements, can be added to the glass melt 35 as it is necessary. As contemplated for the present invention, heavy-weight elements, for example, can include lead and zinc while light-weight elements can include Lithium or Boron.

After altering the specific gravity of the glass melt 35, the mixture of the glass-coated kernels 12 with the glass melt 35 is then cooled, as indicated by action block 56 in FIG. 3, in any cooling unit 58 (as shown in FIG. 4) well known in the pertinent art. As a result, the glass melt 35 is solidified into bulk vitrification glass, and the glass-coated kernels 12 are vitrified in a glass pebble 60, as shown in FIG. 4.

Preferably, the glass pebble 60 can be a substantially sphere-shaped configuration, as shown in FIG. 4. Based upon the amount of kernels 12 per volume of glass melt 35, and the amount of heat that must be removed from the surface of the spherical bulk vitrification glass, the size of the spherical glass pebble 60 (i.e. the radius R) can be determined. Alternatively, however, as contemplated for the present invention, the glass pebble 60 can be cylindrical-shaped.

While the particular Encapsulation of Spent Ceramic Nuclear Fuel as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for vitrifying a plurality of kernels of nuclear waste comprising the steps of:
coating the kernels with a glass layer having a variable thermal expansion coefficient across the glass layer, and having a softening temperature;
mixing the plurality of glass-coated kernels with a glass melt to form a mixture, wherein the glass melt and the kernels have a substantially same specific gravity to obtain a substantially uniform distribution of the glass-coated kernels throughout the glass melt, and further wherein the glass melt has a softening temperature lower than the softening temperature of the glass layer; and
cooling the mixture to solidify the glass melt and vitrify the kernels therein.

2. A method as recited in claim 1 wherein the coating step is accomplished by chemical vapor distribution in a fluidized bed processor, wherein the fluidized bed processor includes a chamber, and further wherein the chamber contains a silicon gas mixture for making the glass layer.

3. A method as recited in claim 2 further comprising the step of selectively adding a mixing gas with the silicon gas mixture for varying the thermal expansion coefficient of the glass layer as the glass layer is deposited onto the kernels.

4. A method as recited in claim 3 wherein the mixing gas is selected from the group consisting of silane, borane, phosgen, triiosbutylaluminum and arsine.

5. A method as recited in claim 1 wherein the plurality of kernels have a core including the nuclear waste and a layer of silicon carbide surrounding the core, and wherein the variable thermal expansion coefficient of the glass layer is between approximately 0.5×10⁻⁶/°C. and approximately 9×10⁻⁶/°C., wherein the thermal expansion coefficient of the glass layer nearest the layer of silicon carbide is substantially equal to the thermal expansion coefficient of silicon carbide, and further wherein the thermal expansion coefficient of the glass layer nearest the glass melt is substantially equal to the thermal expansion coefficient of the glass melt.

6. A method as recited in claim 5 wherein the thermal expansion coefficient of silicon carbide is approximately 4.5×10⁻⁶/°C.

7. A method as recited in claim 1 further comprising the step of selectively adding an element to the glass melt for varying the specific gravity of the glass melt to substantially equal the specific gravity of the glass-coated kernels.

8. A method as recited in claim 1 wherein the cooled mixture is substantially sphere-shaped.

9. A method as recited in claim 1 wherein the cooled mixture is substantially cylindrical-shaped.

10. A method as recited in claim 1 wherein each kernel has a layer of carbon surrounding the layer of silicon carbide, and is embedded in graphite, and said method further comprises the step of removing the graphite and the layer of carbon prior to the coating step.

11. A method for vitrifying a plurality of nuclear waste kernels wherein the kernels have a core including the nuclear waste, a layer of silicon carbide surrounding the core, a layer of carbon surrounding the silicon carbide layer, and wherein the kernels are embedded in graphite, the method comprising the steps of:
removing the graphite and the carbon layer from the plurality of kernels;
coating the silicon carbide layer of each kernel with a glass layer having a thermal expansion coefficient, and having a softening temperature;
varying the thermal expansion coefficient across the glass layer during the coating step;
mixing the plurality of glass-coated kernels with a glass melt to form a mixture, wherein the glass melt and the kernels have a substantially same specific gravity to obtain a substantially uniform distribution of the glass-coated kernels throughout the glass melt, and further wherein the glass melt has a softening temperature lower than the softening temperature of the glass layer; and
cooling the mixture to solidify the glass melt and vitrify the kernels therein.

12. A method as recited in claim 11 wherein the coating step is accomplished by chemical vapor distribution in a fluidized bed processor, wherein the fluidized bed processor includes a chamber, and further wherein the chamber contains a silicon gas mixture for making the glass layer.

13. A method as recited in claim 12 wherein said varying step is accomplished by selectively adding a mixing gas with the silicon gas mixture in the chamber of the fluidized bed processor as the glass layer is deposited onto the silicon carbide layer of the kernels.

14. A method as recited in claim 13 wherein the variable thermal expansion coefficient of the glass layer is between approximately 0.5×10⁻⁶/°C. and approximately 9×10⁻⁶/°C., wherein the thermal expansion coefficient of the portion of the glass layer nearest the silicon carbide layer is substantially equal to the thermal expansion coefficient of silicon carbide, and further wherein the thermal expansion coefficient of the portion of the glass layer nearest the glass melt is substantially equal to the thermal expansion coefficient of the glass melt.

15. A method as recited in claim 11 further comprising the step of selectively adding an element to the glass melt for varying the specific gravity of the glass melt to substantially equal the specific gravity of the glass-coated kernels.

16. A method as recited in claim 11 wherein the cooled mixture is substantially sphere-shaped.

17. A device for storing nuclear waste which comprises:
a glass container having a softening temperature; and
a plurality of kernels embedded in said glass container, said plurality of kernels having a core including said nuclear waste, and a glass layer surrounding said core, said glass layer having a variable thermal expansion coefficient across the glass layer, and having a softening temperature higher than said softening temperature of said glass container, and wherein said kernels and said glass container have a substantially same specific gravity to obtain a substantially uniform distribution of said kernels throughout said glass container.

18. A device as recited in claim 17 wherein said glass container is substantially sphere-shaped.

19. A device as recited in claim 17 wherein said glass container is substantially cylindrical-shaped.

20. A device as recited in claim 17 wherein said kernels have a layer of silicon carbide between said core and said glass layer, and wherein the variable thermal expansion coefficient of said glass layer is between approximately 0.5×10⁻⁶/°C. and approximately 9×10⁻⁶/°C., wherein the thermal expansion coefficient of said glass layer nearest said layer of silicon carbide is substantially equal to the thermal expansion coefficient of silicon carbide, and further wherein the thermal expansion coefficient of said glass layer nearest said glass container is substantially equal to the thermal expansion coefficient of the glass container.
